(19) United States
(12) Patent Application Publication
(10) Pub. No.: US 2020/0183789 A1
(43) Pub. Date: Jun. 11, 2020

(54) INSTALLATION FILE PROCESSING METHOD AND DEVICE, AND SERVER

(71) Applicant: BEIJING KINGSOFT INTERNET SECURITY SOFTWARE CO., LTD., Beijing (CN)

(72) Inventors: Zheng Wei, Beijing (CN); Chen Zhao, Beijing (CN)

(73) Assignee: BEIJING KINGSOFT INTERNET SECURITY SOFTWARE CO., LTD., Beijing (CN)

(21) Appl. No.: 16/317,706

(22) PCT Filed: Jul. 10, 2017
(86) PCT No.: PCT/CN2017/092422

§ 371 Date: Mar. 26, 2019

(30) Foreign Application Priority Data
Jul. 13, 2016 (CN) 201610550954.9

(51) Int. Cl. G06F 11/14; G06F 11/07; G06F 8/61; G06F 8/71; G06F 9/445; G06F 9/54

(52) U.S. Cl. CPC G06F 11/1433; G06F 11/0772; G06F 11/076; G06F 9/542; G06F 8/71; G06F 9/445; G06F 8/61

(57) ABSTRACT

Embodiments of the present disclosure provide an installation file processing method and device, and a server. The method includes: receiving first installation information sent by a client and indicating a failed installation of a target software, the first installation information including a target software identifier, a first version number corresponding to the target software, installation environment information and installation parameter information; obtaining multiple pieces of second installation information each including the target software identifier and the installation environment information, and generating parameter statistics results corresponding to multiple second version numbers contained in the multiple pieces of second installation information; and selecting a target version number of which the parameter statistics result meets a first preset condition from the multiple second version numbers, and sending an installation file corresponding to the target version number to the client.

### CROSS-REFERENCE TO RELATED APPLICATION

This application is a U.S. national stage entry under 35 U.S.C. § 371 of International Application No. PCT/CN2017/092422, filed on Jul. 10, 2017, claiming priority to Chinese Patent Application Serial No. 201610550954.9, filed on Jul. 13, 2016. The entire content of each of these applications is herein incorporated by reference for all purposes.

### FIELD

The present disclosure relates to communication technology field, and more particularly, to an installation file processing method and device, and a server.

### BACKGROUND

With the development of computer science and technology and the continuous expansion of computer application fields, computers have been closely related to people's daily work and lives. In a modern computer architecture, each kind of external hardware device, such as a display card, a network card, a keyboard, a mouse, and a hard disk, needs to install a correct driver program, so that the computer operating system can use the external devices through the running of the driver programs. Most of existing hardware driver programs are not provided by the operating system but can be installed by users on their own. There are many kinds of hardware, and the same hardware may have different driver programs for different operating systems. Thus, for users who are not familiar with computer operation, a failed installation of a driver program often occurs, which results in that the hardware cannot function properly.

In the related art, a server can collect installation failure information of some driver programs. However, the server often waits for the collected installation failure information to reach a certain amount before an overall analysis and processing. The long waiting time affects the installation efficiency of driver programs.

### SUMMARY

Embodiments of the present disclosure provide an installation file processing method and device, and a server, which can timely solve an installation failure problem of a target software in the client and improve a successful installation efficiency of the target software.

An installation file processing method includes:

receiving first installation information sent by a client and indicating a failed installation of a target software, the first installation information including a target software identifier, a first version number corresponding to the target software, installation environment information and installation parameter information;

obtaining multiple pieces of second installation information each including the target software identifier and the installation environment information, and generating parameter statistics results corresponding to multiple second version numbers contained in the multiple pieces of second installation information;

selecting a target version number of which the parameter statistics result meets a first preset condition from the multiple second version numbers, and sending an installation file corresponding to the target version number to the client.

An installation file processing device includes:

an information receiving unit, configured to receive first installation information sent by a client and indicating a failed installation of a target software, the first installation information including a target software identifier, a first version number corresponding to the target software, installation environment information and installation parameter information;

a first obtaining unit, configured to obtain multiple pieces of second installation information each including the target software identifier and the installation environment information, and generate parameter statistics results corresponding to multiple second version numbers contained in the multiple pieces of second installation information;

a first selecting unit, configured to select a target version number of which the parameter statistics result meets a first preset condition from the multiple second version numbers; and

a file sending unit, configured to send an installation file corresponding to the target version number to the client.

A server includes a processor and a memory, wherein

the memory is configured to store executable program codes; the processor is configured to run a program corresponding to the executable program codes by reading the executable program codes stored in the memory, to perform the following operations:

receiving first installation information sent by a client and indicating a failed installation of a target software, the first installation information including a target software identifier, a first version number corresponding to the target software, installation environment information and installation parameter information;

obtaining multiple pieces of second installation information each including the target software identifier and the installation environment information, and generating parameter statistics results corresponding to multiple second version numbers contained in the multiple pieces of second installation information;

selecting a target version number of which the parameter statistics result meets a first preset condition from the multiple second version number and sending an installation file corresponding to the target version number to the client.

A storage medium stores thereon with one or more programs that, when executed by a device, perform the following steps:

receiving first installation information sent by a client and including failed installation of a target software, the first installation information including a target software identifier, a first version number corresponding to the target software, installation environment information and installation parameter information;

obtaining multiple pieces of second installation information each including the target software identifier and the installation environment information, and generating parameter statistics results corresponding to multiple second version numbers contained in the multiple pieces of second installation information; and

selecting a target version number of which the parameter statistics result meets a first preset condition from the multiple second version numbers, and sending an installation file corresponding to the target version number to the client.

### BRIEF DESCRIPTION OF THE DRAWINGS

In order to clearly illustrate technical solutions of embodiments of the present disclosure, a brief description of drawings used in embodiments is given below. Obviously, the drawings in the following descriptions are only part of embodiments of the present disclosure, and for those skilled in the art, other drawings can be obtained according to these drawings without creative labor.

FIG. 1 is a flow chart illustrating an installation file processing method according to embodiments of the present disclosure;

FIG. 2 is a flow chart illustrating another installation file processing method according to embodiments of the present disclosure;

FIG. 3 is a block diagram illustrating an installation file processing device according to embodiments of the present disclosure;

FIG. 4 is a block diagram illustrating another installation file processing device according to embodiments of the present disclosure;

FIG. 5 is a block diagram illustrating a server according to embodiments of the present disclosure.

### DETAILED DESCRIPTION

Reference will be made clearly and completely to technical solutions in the embodiments of the present disclosure with accompanying drawings. Obviously, the embodiments described here are only part of the embodiments of the present disclosure and are not all embodiments of the present disclosure. Based on the embodiments of the present disclosure, other embodiments obtained by those skilled in the art without creative labor are within scope of the present disclosure.

The installation file processing method provided by embodiments of the present disclosure may be applied to a scenario in which an installation file is processed after a failed installation of a target driver program, for example, including: receiving first installation information sent by a client and including the failed installation of a target software, the first installation information including a first version number corresponding to the target software, installation environment information and installation parameter information; obtaining multiple pieces of second installation information each including the target software identifier and the installation environment information, and generating parameter statistics results corresponding to multiple second version numbers contained in the multiple pieces of second installation information; selecting a target version number of which the parameter statistics result meets a first preset condition from the multiple second version numbers, and sending an installation file corresponding to the target version number to the client. In this way, for the client with failed installation of the target driver program, the installation file that can be successfully installed can be timely sent to the client, making the target driver program run normally in the client and improving the successful installation efficiency of the target driver program.

A server involved in embodiments of the present disclosure may be a background device serving for installing application software, driver programs and the like, the client involved may be any device with storage and communication capabilities, for example, a tablet computer, a mobile phone, a Personal Computer (PC), a laptop, a vehicle-mounted equipment, a network television and so on, the installation file processing device involved may be a background device serving for installing application software, driver programs and the like, or an installation file processing module embedded in a background device serving for installing application software, driver programs and the like.

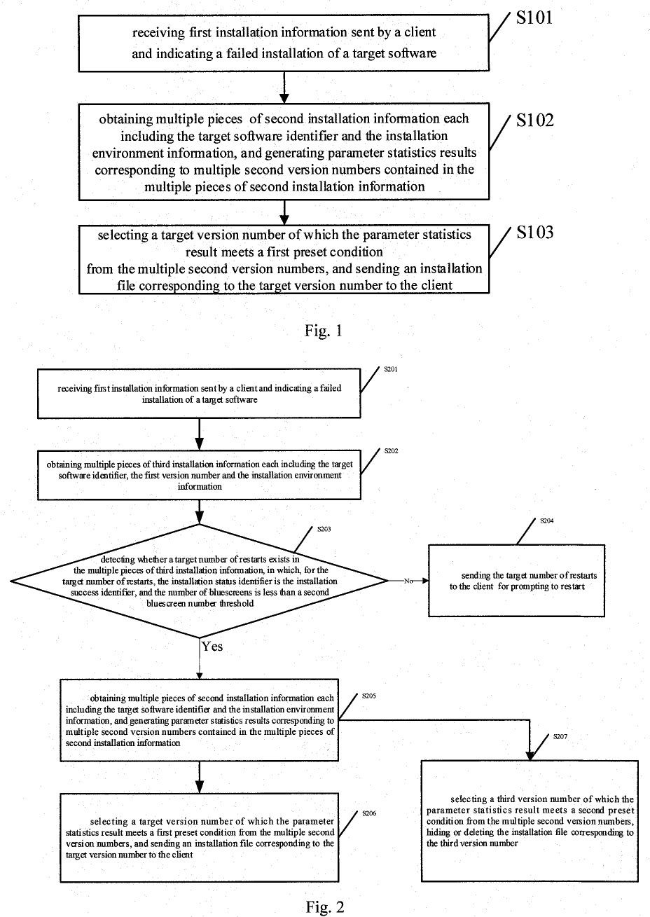

Referring to FIG. 1 and FIG. 2 together, the installation file processing method provided by embodiments of the present disclosure is described in detail below.

FIG. 1 is a flow chart illustrating an installation file processing method according to embodiments of the present disclosures. As illustrated in FIG. 1, the method described in embodiments of the present disclosure may include following steps S101 to S103.

At S101, first installation information sent by a client and indicating a failed installation of a target software is received.

Specifically, an installation file processing device receives the first installation information sent by the client and indicating the failed installation of the target software.

The target software may be a driver program, such as a hard disk driver program, a mouse driver program and the like, and may also be an application software, such as an instant messaging software, a shopping software and the like. The first installation information indicating the failed installation of the target software includes a target software identifier, a first version number corresponding to the target software, installation environment information and installation parameter information. The first version number is the version number corresponding to the target software that fails to be installed currently.

Optionally, the installation environment information may include but is not limited to any one or any combination of operating system version information, a hardware identifier, and an installation mode. The operating system version information may include identification information of various versions of UNIX, LINUX, Windows, Mac OS X, Symbian, Android and Kylin OS. For example, the operating system version information is represented by “Windows7 64-bit”. The hardware identifier may be represented by a hardware type, a hardware name, and/or a hardware identification code, for example, the hardware identifier is represented by a hard disk identification code, a network card identifier is represented by a Media Access Control (MAC) address, and so on. The installation mode includes an upgrade installation mode or an initial installation mode. It can be understood that, if there are other version numbers of the target software existing in the client before installing the target software corresponding to the first version number, the installation mode is determined to be the upgrade installation mode, and if no other versions of the target software exist in the client, the installation mode is determined to be the initial installation mode.

Optionally, the installation parameter information is configured to represent the installation status of the target software and/or the running status of the client during the installation process, and the installation parameter information may include but is not limited to any one or any combination of the installation status identifier of the target software and the number of bluescreens of the client in the installation process of the target software. The installation status identifier includes an installation success identifier or an installation failure identifier. In a feasible solution, the client may obtain the successful or failed installation of the target software through registry data, or may determine the successful or failed installation of the target software by obtaining the files under the installation path of the target software. Further, the client may record the corresponding installation status identifier in the installation parameter information according to the determined installation status.

For example, the target software is Realtek network card driver, the installation information received by the installation file processing device includes the driver program name of realtek_rtl.exe, the version number of 2.01, the installation mode of upgrade installation mode, the operating system of win7-64, the hardware name of Realtek PCIe GBE Family Controller, the hardware ID of PCI\VEN_10EC&DEV_8168&SUBSYS_85541043, the installation status of installation failure and the number of installation bluescreens of 0. Such information is merely exemplary and embodiments of the present disclosure do not limit any possible installation information of other target software.

At S102, multiple pieces of second installation information each including the target software identifier and the installation environment information are obtained, and parameter statistics results corresponding to multiple second version numbers contained in the multiple pieces of second installation information are generated.

Specifically, the installation file processing device obtains multiple pieces of second installation information each including the target software identifier and the installation environment information, and generates parameter statistics results corresponding to multiple second version numbers contained in the multiple pieces of second installation information. In a feasible solution, the installation file processing device obtains multiple pieces of installation information of the target software according to the target software identifier, and screens out multiple pieces of second installation information with the same installation environment information as the target software from the multiple pieces of installation information of the target software. The term “second” in the “second installation information” is to indicate that the obtained installation information includes the target software identifier and the installation environment information, the second installation information includes the same kind of information as the first installation information may include, and the specific content of each information type is determined by the sender of the second installation information.

In a feasible solution, the installation file processing device receives and stores installation information regarding successful installation of the target software and installation information regarding failed installation of the target software sent by at least one terminal. When receiving the first installation information sent by the client and indicating failed installation of the target software, the installation file processing device selects the multiple pieces of second installation information each including the target software identifier and the installation environment information from pre-stored installation information indicating successful installation of the target software and pre-stored installation information indicating failed installation of the target software.

Further, the installation file processing device generates the parameter statistics results corresponding to the multiple second version numbers contained in the multiple pieces of second installation information. The parameter statistics result includes at least one of installation success data and a number of installation bluescreens for each second version number. The installation success data includes a number of successful installations or an installation success probability. In a feasible solution, the installation file processing device collates the installation parameter information of each second version number, for example, counts the total number of installation success identifiers contained in the multiple pieces of second installation information for the same second version number, counts the total number of installation success identifiers or installation failure identifiers contained in the multiple pieces of second installation information for the same second version number, and counts the total number of installation bluescreens contained in the multiple pieces of second installation information for the same second version number, and further generates the parameter statistics results based on such collation.

At S103, a target version number of which the parameter statistics result meets a first preset condition is selected from the multiple second version numbers, and an installation file corresponding to the target version number is sent to the client.

Specifically, the installation file processing device selects the target version number of which the parameter statistics result meets the first preset condition from the multiple second version numbers, and sends the installation file corresponding to the target version number to the client. The first preset condition is set by the installation file processing device, and is a condition indicating a higher installation success rate and/or less impact on the running of the client, so that the client can successfully install the target software according to the installation file. In embodiments of the present disclosure, the installation file may be a program file of the target version number, a network address for obtaining the program file of the target version number, and the like.

In a feasible solution, when the parameter statistics result includes the installation success data, the target version number of which the installation success data is greater than a success data threshold is selected from the multiple second version numbers; or, when the parameter statistics result includes the number of installation bluescreens, the target version number of which the number of installation bluescreens is less than a first bluescreen number threshold is selected from the multiple second version numbers; or, when the parameter statistics result includes the installation success data and the number of installation bluescreens, the target version number of which the installation success data is greater than the success data threshold and the number of installation bluescreens is less than the first bluescreen number threshold is selected from the multiple second version numbers. When the installation success data is the number of successful installations, the success data threshold is the number threshold of successful installations, and when the installation success data is the installation success probability, the success data threshold is the success probability threshold. In embodiments of the present disclosure, the success data threshold and the first bluescreen number threshold are customizable in the installation file processing device.

In embodiments of the present disclosure, the first installation information sent by the client and indicating the failed installation of the target software is received, multiple pieces of second installation information each containing the same installation environment information as the first installation information are obtained, and the parameter statistics results corresponding to multiple second version numbers contained in the multiple pieces of second installation information are generated, the target version number of which the parameter statistics result meets the first preset condition is selected from the multiple second version numbers and the installation file corresponding to the target version number is sent to the client. In this manner, for the client with failed installation of the target software, the installation file that can be successfully installed can be timely sent to the client, making the target software run normally in the client and improving the successful installation efficiency of the target software.

FIG. 2 is a flow chart illustrating another installation file processing method according to embodiments of the present disclosures. As illustrated in FIG. 2, the method described in embodiments of the present disclosure may include following steps S201 to S207.

At S201, first installation information sent by a client and indicating failed installation of a target software is received.

Specifically, an installation file processing device receives the first installation information sent by the client and indicating the failed installation of the target software. The target software may be a driver program, such as a hard disk driver program, a mouse driver program and the like, and may also be an application software, such as an instant messaging software, a shopping software and the like. The first installation information indicating the failed installation of the target software includes a target software identifier, a first version number corresponding to the target software, installation environment information and installation parameter information. The first version number is the version number corresponding to the target software that fails to be installed currently. Optionally, the first installation information further includes the number of restarts of the client when the target software installation fails. The number of restarts may be 0, 1, 2, etc.

Optionally, the installation environment information may include but is not limited to any one or any combination of operating system version information, a hardware identifier, and an installation mode. The operating system version information may include identification information of various versions of UNIX, LINUX, Windows, Mac OS X, Symbian, Android and Kylin OS. For example, the operating system version information is represented by “Windows7 64-bit”. The hardware identifier may be represented by a hardware type, a hardware name, and/or a hardware identification code, for example, the hardware identifier is represented by a hard disk identification code, a network card identifier is represented by a Media Access Control (MAC) address, and so on. The installation mode includes an upgrade installation mode or an initial installation mode. It can be understood that, if there are other version numbers of the target software existing in the client before installing the target software corresponding to the first version number, the installation mode is determined to be the upgrade installation mode, and if no other versions of the target software exist in the client, the installation mode is determined to be the initial installation mode.

Optionally, the installation parameter information is configured to represent the installation status of the target software and/or the running status of the client during the installation process, and the installation parameter information may include but is not limited to any one or any combination of an installation status target software identifier and the number of bluescreens of the client in the installation process of the target software. The installation status identifier includes an installation success identifier or an installation failure identifier. In a feasible solution, the client may obtain the successful or failed installation of the target software through registry data, or may determine the successful or failed installation of the target software by obtaining the files under the installation path of the target software. Further, the client may record the corresponding installation status identifier in the installation parameter information according to the determined installation status.

For example, the target software is Realtek network card driver, the installation information received by the installation file processing device includes the driver program name of realtek_rtl.exe, the version number of 2.01, the installation mode of upgrade installation mode, the operating system of win7-64, the hardware name of Realtek PCIe GBE Family Controller, the hardware ID of PCI\VEN_10EC&DEV_8168&SUBSYS_85541043, the installation status of installation failure, the number of installation bluescreens of 0, and the number of restarts of the client of 1. Such information is merely exemplary and embodiments of the present disclosure do not limit any possible installation information of other target software.

At S202, multiple pieces of third installation information each including the target software identifier, the first version number and the installation environment information are obtained.

Specifically, the installation file processing device obtains multiple pieces of third installation information each including the target software identifier, the first version number and the installation environment information. In a feasible solution, the installation file processing device obtains multiple pieces of installation information of the target software according to the target software identifier, and screens out multiple pieces of third installation information with the same first version number and the same installation environment information as the target software from the multiple pieces of installation information of the target software. The term “third” in the “third installation information” is to indicate that the obtained installation information contains the target software identifier, the first version number and the installation environment information, the third installation information includes the same kind of information as the first installation information may include, and the specific content of each information type is determined by the sender of the third installation information. It is appreciated that, the multiple pieces of third installation information include the installation information of the target software represented by the target software identifier and first version number under respective numbers of restarts based on the same installation environment information.

At S203, it is detected whether a target number of restarts exists in the multiple pieces of third installation information, in which, for the target number of restarts, the installation status identifier is the installation success identifier, and the number of bluescreens is less than a second bluescreen number threshold.

Specifically, the installation file processing device detects whether a target number of restarts exists in the multiple pieces of third installation information, in which, for the target number of restarts, the installation status identifier is the installation success identifier, and the number of bluescreens is less than a second bluescreen number threshold. If the target number of restarts exists, the method proceeds to step S204, and if the target number of restarts does not exist, the method proceeds to step S205.

In a feasible solution, the installation file processing device may detect whether the target number of restarts of which a second parameter statistics result meets a third preset condition exists in the multiple pieces of third installation information, in which, in the second parameter statistics result, one number of restarts corresponds to one result, each result may include a second installation success data and/or a second number of installation bluescreens, and the second installation success data includes the second number of successful installations or the second installation success probability. For example, if at least one number of restarts corresponding to which the second installation success data is greater than the installation success threshold and the second number of installation bluescreens is greater than the second bluescreen number threshold exists in the multiple numbers of restarts, it is determined that the target number of restarts exists, and the target number of restarts is the number of restarts of which the second installation success data is greater than the installation success threshold; otherwise, it is determined that the target number of restarts does not exist. In an optional solution, the installation file processing device may also determine the target number of restarts in term of the second installation success data or in term of the second number of installation bluescreens. For example, if at least one number of restarts corresponding to which the second installation success data is greater than the installation success threshold exists in the multiple numbers of restarts, it is determined that the target number of restarts exists, and the target number of restarts is the number of restarts of which the second installation success data is greater than the installation success threshold; otherwise, it is determined that the target number of restarts does not exist. Or, if at least one number of restarts corresponding to which the second number of installation bluescreens is greater than the second bluescreen number threshold, it is determined that the target number of restarts exists, and the target number of restarts is the number of restarts of which the second number of installation bluescreens is greater than the second bluescreen number threshold; otherwise, it is determined that the target number of restarts does not exist.

At S204, the target number of restarts is sent to the client for prompting to restart.

Specifically, if it is determined that the target number of restarts exists in step S203, it indicates that under the target number of restarts, installing the target software of the first version number based on the installation environment information has a higher success rate and a lower number of bluescreens. Thus, the installation file processing device sends the target number of restarts to the client for prompting to restart, so that the client can successfully install the target software without re-installing the target software of other version numbers, improving the installation efficiency of target software.

At S205, multiple pieces of second installation information each including the target software identifier and the installation environment information are obtained, and parameter statistics results corresponding to multiple second version numbers contained in the multiple pieces of second installation information are generated.

Specifically, if it is determined that the target number of restarts does not exist in step S203, it indicates that under the multiple numbers of restarts, installing the target software of the first version number based on the installation environment information has a lower success rate or a higher number of bluescreens. Thus, the installation file processing device obtains multiple pieces of second installation information each including the target software identifier and the installation environment information, and generates parameter statistics results corresponding to multiple second version numbers contained in the multiple pieces of second installation information. In a feasible solution, the installation file processing device obtains multiple pieces of installation information of the target software according to the target software identifier, and screens out multiple pieces of second installation information with the same installation environment information as the target software from the multiple pieces of installation information of the target software. The term “second” in the “second installation information” is to indicate that the obtained installation information includes the target software identifier and the installation environment information, the second installation information includes the same kind of information as the first installation information may include, and the specific content of each information type is determined by the sender of the second installation information.

In a feasible solution, the installation file processing device receives and stores installation information regarding successful installation of the target software and installation information regarding failed installation of the target software sent by at least one terminal. When receiving the first installation information sent by the client and indicating the failed installation of the target software, the installation file processing device selects the multiple pieces of second installation information each including the target software identifier and the installation environment information from pre-stored installation information indicating successful installation of the target software and pre-stored installation information indicating failed installation of the target software.

Further, the installation file processing device generates parameter statistics results corresponding to multiple second version numbers contained in the multiple pieces of second installation information. The parameter statistics result includes at least one of installation success data and a number of installation bluescreens for each second version number. The installation success data includes a number of successful installations or an installation success probability. In a feasible solution, the installation file processing device collates the installation parameter information of each second version number, for example, counts the total number of installation success identifiers contained in multiple pieces of second installation information for the same second version number, counts the total number of installation success identifiers or installation failure identifiers contained in the multiple pieces of second installation information for the same second version number, counts the total number of installation bluescreens contained in the multiple pieces of second installation information for the same second version number, and further generates the parameter statistics results based on such collation.

At S206, a target version number of which the parameter statistics result meets a first preset condition is selected from the multiple second version numbers, and an installation file corresponding to the target version number is sent to the client.

Specifically, the installation file processing device selects the target version number of which the parameter statistics result meets the first preset condition from the multiple second version numbers, and sends the installation file corresponding to the target version number to the client. The first preset condition is set by the installation file processing device, and is a condition indicating a higher installation success rate and/or less impact on the running of the client, so that the client can successfully install the target software according to the installation file. In embodiments of the present disclosure, the installation file may be a program file with the target version number, a network address for obtaining the program file with the target version number, and the like.

In a feasible solution, when the parameter statistics result includes the installation success data, the target version number of which the installation success data is greater than a success data threshold is selected from the multiple second version numbers; or, when the parameter statistics result includes the number of installation bluescreens, the target version number of which the number of installation bluescreens is less than a first bluescreen number threshold is selected from the multiple second version numbers; or, when the parameter statistics result includes the installation success data and the number of installation bluescreens, the target version number of which the installation success data is greater than the success data threshold and the number of installation bluescreens is less than the first bluescreen number threshold is selected from the multiple second version numbers. When the installation success data is the number of successful installations, the success data threshold is the number threshold of successful installations, and when the installation success data is the installation success probability, the success data threshold is the success probability threshold. In embodiments of the present disclosure, the success data threshold and the first bluescreen number threshold are customizable in the installation file processing device.

At S207, a third version number of which the parameter statistics result meets a second preset condition is selected from the multiple second version numbers, and the installation file corresponding to the third version number is hidden or deleted.

Specifically, the installation file processing device selects the third version number of which the parameter statistics result meets the second preset condition from the multiple second version numbers, and hides or deletes the installation file corresponding to the third version number. The second preset condition is set by the installation file processing device, and is a condition indicating a lower installation success rate and/or high impact on the running of the client. By hiding or deleting the installation file corresponding to the third version number that meets the second preset condition, the client will not find and install the installation file corresponding to the third version number, thus reducing the possibility of the client failing to install the third version of the target software.

In a feasible solution, when the parameter statistics result includes the installation success data, the third version number of which the installation success data is less than a success data threshold is selected from the multiple second version numbers, or, when the parameter statistics result includes the number of installation bluescreens, the third version number of which the number of installation bluescreens is greater than a first bluescreen number threshold is selected from the multiple second version numbers; or, when the parameter statistics result includes the installation success data and the number of installation bluescreens, the third version number of which the installation success data is less than the success data threshold and the number of installation bluescreens is greater than the first bluescreen number threshold is selected from the multiple second version numbers.

It should be noted that, the success data threshold and the first bluescreen number threshold in step S206 and step S207 may be the same or different in value, which is not limited in embodiments of the present disclosure.

In embodiments of the present disclosure, the first installation information sent by the client and indicating the failed installation of the target software is received, multiple pieces of second installation information each containing the same installation environment information as the first installation information are obtained, and the parameter statistics results corresponding to multiple second version numbers contained in the multiple pieces of second installation information are generated, the target version number of which the parameter statistics result meets the first preset condition is selected from the multiple second version numbers and the installation file corresponding to the target version number is sent to the client. In this manner, for the client with failed installation of the target software, the installation file that can be successfully installed can be timely sent to the client, making the target software run normally in the client and improving the successful installation efficiency of the target software.

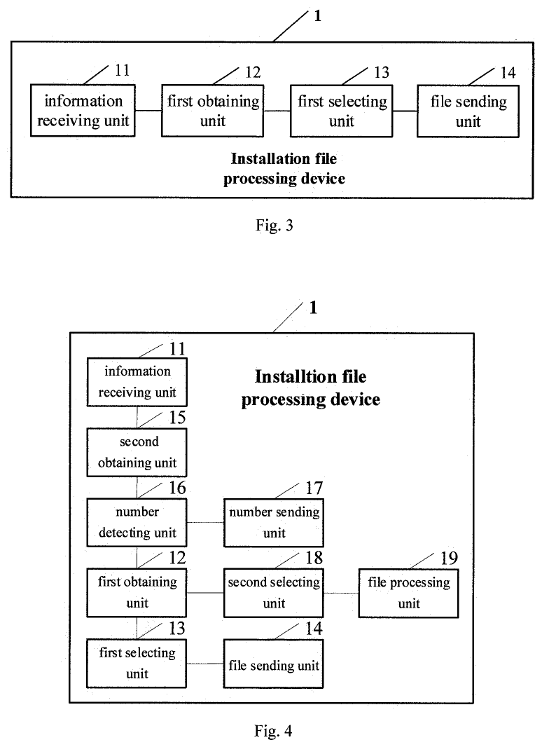

FIG. 3 is a block diagram illustrating an installation file processing device according to embodiments of the present disclosure. As illustrated in FIG. 3, the installation file processing device 1 described in embodiments of the present disclosure may include an information receiving unit 11, a first obtaining unit 12, a first selecting unit 13 and a file sending unit 14.

The information receiving unit 11 is configured to receive first installation information sent by a client and indicating a failed installation of a target software, the first installation information including a target software identifier, a first version number corresponding to the target software, installation environment information and installation parameter information.

Specifically, the information receiving unit 11 receives the first installation information sent by the client and indicating the failed installation of the target software. The target software may be a driver program, such as a hard disk driver program, a mouse driver program and the like, and may also be an application software, such as an instant messaging software, a shopping software and the like. The first installation information indicating the failed installation of the target software includes a target software identifier, a first version number corresponding to the target software, installation environment information and installation parameter information. The first version number is the version number corresponding to the target software that fails to be installed currently.

Optionally, the installation environment information may include but is not limited to any one or any combination of operating system version information, a hardware identifier, and an installation mode. The operating system version information may include identification information of various versions of UNIX, LINUX, Windows, Mac OS X, Symbian, Android and Kylin OS. For example, the operating system version information is represented by “Windows7 64-bit”. The hardware identifier may be represented by a hardware type, a hardware name, and/or a hardware identification code, for example, the hardware identifier is represented by a hard disk identification code, a network card identifier is represented by a Media Access Control (MAC) address, and so on. The installation mode includes an upgrade installation mode or an initial installation mode. It is appreciated that, if there are other version numbers of the target software existing in the client before installing the target software corresponding to the first version number, the installation mode is determined to be the upgrade installation mode, and if no other versions of the target software exist in the client, the installation mode is determined to be the initial installation mode.

Optionally, the installation parameter information is configured to represent the installation status of the target software and/or the running status of the client during the installation process, and the installation parameter information may include but is not limited to any one or any combination of an installation status target software identifier and the number of bluescreens of the client in the installation process of the target software. The installation status identifier includes an installation success identifier or an installation failure identifier. In a feasible solution, the client may obtain the successful or failed installation of the target software through registry data, or may determine the successful or failed installation of the target software determined by obtaining the files under the installation path of the target software. Further, the client may record the corresponding installation status identifier in the installation parameter information according to the determined installation status.

For example, the target software is Realtek network card driver, the installation information received by the installation file processing device includes the driver program name of realtek_rtl.exe, the version number of 2.01, the installation mode of upgrade installation mode, the operating system of win7-64, the hardware name of Realtek PCIe GBE Family Controller, the hardware ID of PCI\VEN_10EC&DEV_8168&SUBSYS_85541043, the installation status of installation failure and the number of installation bluescreens of 0. Such information is merely exemplary and embodiments of the present disclosure do not limit any possible installation information of other target software.

The first obtaining unit 12 is configured to obtain multiple pieces of second installation information each including the target software identifier and the installation environment information, and generate parameter statistics results corresponding to multiple second version numbers contained in the multiple pieces of second installation information.

Specifically, the first obtaining unit 12 obtains multiple pieces of second installation information each including the target software identifier and the installation environment information, and generates parameter statistics results corresponding to multiple second version numbers contained in the multiple pieces of second installation information. In a feasible solution, the first obtaining unit 12 obtains multiple pieces of installation information of the target software according to the target software identifier, and screens out multiple pieces of second installation information with the same installation environment information as the target software from the multiple pieces of installation information of the target software. The term “second” in the “second installation information” is to indicate that the obtained installation information includes the target software identifier and the installation environment information, the second installation information includes the same kind of information as the first installation information may include, and the specific content of each information type is determined by the sender of the second installation information.

In a feasible solution, the information receiving unit 11 receives and stores installation information regarding successful installation of the target software and installation information regarding failed installation of the target software sent by at least one terminal. When the information receiving unit 11 receives the first installation information sent by the client and indicating the failed installation of the target software, the first obtaining unit 12 selects multiple pieces of second installation information each including the target software identifier and the installation environment information from pre-stored installation information indicating successful installation of the target software and pre-stored installation information indicating failed installation of the target software.

Further, the first obtaining unit 12 generates parameter statistics results corresponding to multiple second version numbers contained in the multiple pieces of second installation information. The parameter statistics result includes at least one of installation success data and a number of installation bluescreens for each second version number. The installation success data includes a number of successful installations or an installation success probability. In a feasible solution, the first obtaining unit 12 collates the installation parameter information of each second version number, for example, counts the total number of installation success identifiers contained in the multiple pieces of second installation information for the same second version number, counts the total number of installation success identifiers or failed installation identifiers contained in the multiple pieces of second installation information for the same second version number, and counts the total number of installation bluescreens contained in the multiple pieces of second installation information for the same second version number, and further generates the parameter statistics results based on such collation.

The first selecting unit 13 is configured to select a target version number of which the parameter statistics result meets a first preset condition from the multiple second version numbers.

Specifically, the first selecting unit 13 selects the target version number of which the parameter statistics result meets the first preset condition from the multiple second version numbers. The first preset condition is set by the installation file processing device 1, and is a condition indicating a higher installation success rate and/or less impact on the running of the client, so that the client can successfully install the target software according to the installation file.

In a feasible solution, when the parameter statistics result includes the installation success data, the target version number of which the installation success data is greater than a success data threshold is selected from the multiple second version numbers; or, when the parameter statistics result includes the number of installation bluescreens, the target version number of which the number of installation bluescreens is less than a first bluescreen number threshold is selected from the multiple second version numbers; or, when the parameter statistics result includes the installation success data and the number of installation bluescreens, the target version number of which the installation success data is greater than the success data threshold and the number of installation bluescreens is less than the first bluescreen number threshold is selected from the multiple second version numbers. When the installation success data is the number of successful installations, the success data threshold is the number threshold of successful installations, and when the installation success data is the installation success probability, the success data threshold is the success probability threshold. In embodiments of the present disclosure, the success data threshold and the first bluescreen number threshold are customizable in the installation file processing device 1.

The file sending unit 14 is configured to send an installation file corresponding to the target version number to the client.

Specifically, the file sending unit 14 sends the installation file corresponding to the target version number to the client. In embodiments of the present disclosure, the installation file may be a program file with the target version number, a network address for obtaining the program file with the target version number, and the like. In this manner, the target software runs normally in the client and the successful installation efficiency of the target software is improved.

In embodiments of the present disclosure, the first installation information sent by the client and indicating the failed installation of the target software is received, multiple pieces of second installation information each containing the same installation environment information as the first installation information are obtained, and the parameter statistics results corresponding to multiple second version numbers contained in the multiple pieces of second installation information are generated, the target version number of which the parameter statistics result meets the first preset condition is selected from the multiple second version numbers and the installation file corresponding to the target version number is sent to the client. In this manner, for the client with failed installation of the target software, the installation file that can be successfully installed can be timely sent to the client, making the target software run normally in the client and improving the successful installation efficiency of the target software.

FIG. 4 is a block diagram illustrating an installation file processing device according to embodiments of the present disclosure. As illustrated in FIG. 4, the installation file processing device 1 described in embodiments of the present disclosure may include an information receiving unit 11, a first obtaining unit 12, a first selecting unit 13, a file sending unit 14, a second obtaining unit 15, a number detecting unit 16, a number sending unit 17, a second selecting unit 18, and a file processing unit 19.

The information receiving unit 11 is configured to receive first installation information sent by a client and indicating a failed installation of a target software, the first installation information including a target software identifier, a first version number corresponding to the target software, installation environment information and installation parameter information.

Specifically, the information receiving unit 11 receives the first installation information sent by the client and indicating the failed installation of target software. The target software may be a driver program, such as a hard disk driver program, a mouse driver program and the like, and may also be an application software, such as an instant messaging software, a shopping software and the like. The first installation information indicating the failed installation of the target software includes a target software identifier, a first version number corresponding to the target software, installation environment information and installation parameter information. The first version number is the version number corresponding to the target software that fails to be installed currently. Optionally, the first installation information further includes a number of restarts of the client when the target software installation fails. The number of restarts may be 0, 1, 2, etc.

Optionally, the installation environment information may include but is not limited to any one or any combination of operating system version information, a hardware identifier, and an installation mode. The operating system version information may include the identification information of various versions of UNIX, LINUX, Windows, Mac OS X, Symbian, Android and Kylin OS. For example, the operating system version information is represented by “Windows7 64-bit”. The hardware identifier may be represented by a hardware type, a hardware name, and/or a hardware identification code, for example, the hardware identifier is represented by a hard disk identification code, a network card identifier is represented by a Media Access Control (MAC) address, and so on. The installation mode includes an upgrade installation mode or an initial installation mode. It is appreciated that, if there are other version numbers of the target software existing in the client before installing the target software corresponding to the first version number, the installation mode is determined to be the upgrade installation mode, and if no other versions of the target software exist in the client, the installation mode is determined to be the initial installation mode.

Optionally, the installation parameter information is configured to represent the installation status of the target software and/or the running status of the client during the installation process, and the installation parameter information may include but is not limited to any one or any combination of an installation status target software identifier and the number of bluescreens of the client in the installation process of the target software. The installation status identifier includes an installation success identifier or an installation failure identifier. In a feasible solution, the client may obtain the successful or failed installation of the target software through registry data, or may determine the successful or failed installation of the target software by obtaining the files under the installation path of the target software. Further, the client may record the corresponding installation status identifier in the installation parameter information according to the determined installation status.

For example, the target software is Realtek network card driver, the installation information received by the installation file processing device includes the driver program name of realtek_rtl.exe, the version number of 2.01, the installation mode of upgrade installation mode, the operating system of win7-64, the hardware name of Realtek PCIe GBE Family Controller, the hardware ID of PCI\VEN_10EC&DEV_8168&SUBSYS_85541043, the installation status of installation failure, the number of installation bluescreens of 0, and the number of restarts of the client of 1. Such information is merely exemplary and embodiments of the present disclosure do not limit any possible installation information of other target software.

The second obtaining unit 15 is configured to obtain multiple pieces of third installation information each including the target software identifier, the first version number and the installation environment information.

Specifically, the second obtaining unit 15 obtains multiple pieces of third installation information each including the target software identifier, the first version number and the installation environment information. In a feasible solution, the second obtaining unit 15 obtains multiple pieces of installation information of the target software according to the target software identifier, and screens out multiple pieces of third installation information with the same first version number and the same installation environment information as the target software from the multiple pieces of installation information of the target software. The term “third” in the “third installation information” is to indicate that the obtained installation information contains the target software identifier, the first version number and the installation environment information, the third installation information includes the same kind of information as the first installation information may include, and the specific content of each information type is determined by the sender of the third installation information. It is appreciated that, the multiple pieces of third installation information include the installation information of the target software represented by the target software identifier and first version number under respective numbers of restarts based on the same installation environment information.

The number detecting unit 16 is configured to detect whether a target number of restarts exists in the multiple pieces of third installation information, in which, for the target number of restarts, the installation status identifier is the installation success identifier, and the number of bluescreens is less than a second bluescreen number threshold.

Specifically, the number detecting unit 16 detects whether the target number of restarts exists in the multiple pieces of third installation information, in which, for the target number of restarts, the installation status identifier is the installation success identifier, and the number of bluescreens is less than a second bluescreen number threshold. If the target number of restarts exists, the number sending unit 17 is executed, and if the target number of restarts does not exist, the first obtaining unit 12 is executed.

In a feasible solution, the number detecting unit 16 may detect whether the target number of restarts of which a second parameter statistics result meets a third preset condition exists in the multiple third installation information, in which, in the second parameter statistics result, one number of restarts corresponds to one result, each result may include a second installation success data and/or a second number of installation bluescreens, and the second installation success data includes the second number of successful installations or the second installation success probability. For example, if at least one number of restarts corresponding to which the second installation success data is greater than the installation success threshold and the second number of installation bluescreens is greater than the second bluescreen number threshold exists in the multiple numbers of restarts, it is determined that the target number of restarts exists, and the target number of restarts is the number of restarts of which the second installation success data is greater than the installation success threshold; otherwise, it is determined that the target number of restarts does not exist. In an optional solution, the number detecting unit 16 may also determine the target number of restarts in term of the second installation success data or in term of the second number of installation bluescreens. For example, if at least one number of restarts corresponding to which the second installation success data is greater than the installation success threshold exists in the multiple numbers of restarts, it is determined that the target number of restarts exists, and the target number of restarts is the number of restarts of which the second installation success data is greater than the installation success threshold; otherwise, it is determined that the target number of restarts does not exist. Or, if at least one number of restarts corresponding to which the second number of installation bluescreens is greater than the second bluescreen number threshold, it is determined that the target number of restarts exists, and the target number of restarts is the number of restarts of which the second number of installation bluescreens is greater than the second bluescreen number threshold; otherwise, it is determined that the target number of restarts does not exist.

The number sending unit 17 is configured to, if the target number of restarts exists, send the target number of restarts to the client for prompting to restart.

Specifically, if the number detecting unit 16 determines that the target number of restarts exists, it indicates that under the target number of restarts, installing the target software of the first version number based on the installation environment information has a higher success rate and a lower number of bluescreens. Thus, the number sending unit 17 sends the target number of restarts to the client for prompting to restart, which enables the client to successfully install the target software without re-installing the target software of other version numbers, improving the installation efficiency of target software.

The first obtaining unit 12 is configured to, if the target number of restarts does not exist, obtain multiple pieces of second installation information each including the target software identifier and the installation environment information, and generate parameter statistics results corresponding to multiple second version numbers contained in the multiple pieces of second installation information.

Specifically, if the number detecting unit 16 determines that the target number of restarts does not exist, it indicates that under the multiple numbers of restarts, installing the target software of the first version number based on the installation environment information has a lower success rate or a higher number of bluescreens. Thus, the first obtaining unit 12 obtains multiple pieces of second installation information each including the target software identifier and the installation environment information, and generates parameter statistics results corresponding to multiple second version numbers contained in the multiple pieces of second installation information. In a feasible solution, the first obtaining unit 12 obtains multiple pieces of installation information of the target software according to the target software identifier, and screens out multiple pieces of second installation information with the same installation environment information as the target software from the multiple pieces of installation information of the target software. The term “second” in the “second installation information” is to indicate that the obtained installation information includes the target software identifier and the installation environment information, the second installation information includes the same kind of information as the first installation information may include, and the specific content of each information type is determined by the sender of the second installation information.

In a feasible solution, the first obtaining unit 12 receives and stores installation information regarding successful installation of the target software and installation information regarding failed installation of the target software sent by at least one terminal. When the information receiving unit 11 receives the first installation information sent by the client and indicating the failed installation of the target software, the first obtaining unit 12 selects multiple pieces of second installation information each including the target software identifier and the installation environment information from pre-stored installation information indicating successful installation of the target software and pre-stored installation information indicating failed installation of the target software.

Further, the first obtaining unit 12 generates the parameter statistics results corresponding to multiple second version numbers contained in the multiple pieces of second installation information. The parameter statistics result includes at least one of installation success data and a number of installation bluescreens for each second version number. The installation success data includes a number of successful installations or an installation success probability. In a feasible solution, the first obtaining unit 12 collates the installation parameter information of each second version number, for example, counts the total number of installation success identifiers contained in the multiple pieces of second installation information for the same second version number, counts the total number of installation success identifiers or installation failure identifiers contained in the multiple pieces of second installation information for the same second version number, and counts the total number of installation bluescreens contained in the multiple pieces of second installation information for the same second version number, and further generates the parameter statistics results based on such collation.

The first selecting unit 13 is configured to select a target version number of which the parameter statistics result meets a first preset condition from the multiple second version numbers.

Specifically, the first selecting unit 13 selects the target version number of which the parameter statistics result meets the first preset condition from the multiple second version numbers. The first preset condition is set by the installation file processing device 1, and is a condition that indicates a higher installation success rate and/or less impact on the running of the client, so that the client can successfully install the target software according to the installation file.

In a feasible solution, when the parameter statistics result includes the installation success data, the target version number of which the installation success data is greater than a success data threshold is selected from the multiple second version numbers; or, when the parameter statistics result includes the number of installation bluescreens, the target version number of which the number of installation bluescreens is less than a first bluescreen number threshold is selected from the multiple second version numbers; or, when the parameter statistics result includes the installation success data and the number of installation bluescreens, the target version number of which the installation success data is greater than the success data threshold and the number of installation bluescreens is less than the first bluescreen number threshold is selected from the multiple second version numbers. When the installation success data is the number of successful installations, the success data threshold is the number threshold of successful installations, and when the installation success data is the installation success probability, the success data threshold is the success probability threshold. In embodiments of the present disclosure, the success data threshold and the first bluescreen number threshold are customizable in the installation file processing device 1.

The file sending unit 14 is configured to send an installation file corresponding to the target version number to the client.

Specifically, the file sending unit 14 sends the installation file corresponding to the target version number to the client. In embodiments of the present disclosure, the installation file may be a program file with the target version number, a network address for obtaining the program file with the target version number, and the like. This makes the target software run normally in the client and improves the successful installation efficiency of the target software.

The second selecting unit 18 is configured to select a third version number of which the parameter statistics result meets a second preset condition from the multiple second version numbers.

Specifically, the second selecting unit 18 selects the third version number of which the parameter statistics result meets the second preset condition from the multiple second version numbers. The second preset condition is set by the installation file processing device 1, and is a condition indicating a lower installation success rate and/or a high impact on the running of the client. In a feasible solution, when the parameter statistics result includes the installation success data, the third version number of which the installation success data is less than a success data threshold is selected from the multiple second version numbers, or, when the parameter statistics result includes the number of installation bluescreens, the third version number of which the number of installation bluescreens is greater than a first bluescreen number threshold is selected from the multiple second version numbers; or, when the parameter statistics result includes the installation success data and the number of installation bluescreens, the third version number of which the installation success data is less than the success data threshold and the number of installation bluescreens is greater than the first bluescreen number threshold is selected from the multiple second version numbers.

The file processing unit 19 is configured to hide or delete the installation file corresponding to the third version number.

Specifically, the file processing unit 19 hides or deletes the installation file corresponding to the third version number, so that the client will not find and install the installation file corresponding to the third version number, thus reducing the possibility of the client failing to install the third version of the target software.

It should be noted that, the success data threshold and the first bluescreen number threshold in embodiments of the present disclosure may be the same or different in value, which is not limited in embodiments of the present disclosure.

In embodiments of the present disclosure, the first installation information sent by the client and indicating the failed installation of the target software is received, multiple pieces of second installation information each containing the same installation environment information as the first installation information are obtained, and the parameter statistics results corresponding to multiple second version numbers contained in the multiple pieces of second installation information are generated, the target version number of which the parameter statistics result meets the first preset condition is selected from the multiple second version numbers and the installation file corresponding to the target version number is sent to the client. In this manner, for the client with failed installation of the target software, the installation file that can be successfully installed can be timely sent to the client, making the target software run normally in the client and improving the successful installation efficiency of the target software.

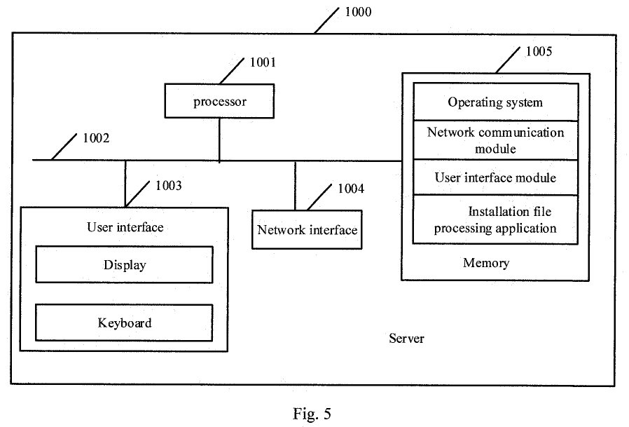

FIG. 5 is a block diagram illustrating a server according to embodiments of the present disclosure. As illustrated in FIG. 5, the server 1000 may include at least one processor 1001, such as CPU, at least one network interface 1004, a user interface 1003, a memory 1005, and at least one communication bus 1002. The communication bus 1002 is configured to realize connection communication between these components. The user interface 1003 may include a display screen (Display), a keyboard (Keyboard). The optional user interface 1003 may further include standard wired interfaces and wireless interfaces. The network interface 1004 optionally may include standard wired interfaces and wireless interfaces (such as WI-FI interfaces). The memory 1005 may be a high speed RAM memory or may be an unstable memory (non-volatile memory), for example at least one disk memory. The memory 1005 optionally may also be at least one storage device located away from the aforementioned processor 1001. As illustrated in FIG. 5, the memory 1005, as a computer storage medium, may include an operating system, a network communication module, a user interface module and an installation file processing application.

In the server 1000 depicted in FIG. 5, the user interface 1003 is mainly configured to receive installation information about the target software sent by the client, and the processor 1001 may be used to invoke the installation file processing application stored in the memory 1005 and perform following operations:

receiving first installation information sent by the client and indicating the failed installation of the target software, the first installation information including a target software identifier, a first version number corresponding to the target software, installation environment information and installation parameter information;

obtaining multiple pieces of second installation information each including the target software identifier and the installation environment information, and generating parameter statistics results corresponding to multiple second version numbers contained in the multiple pieces of second installation information;

selecting a target version number of which the parameter statistics result meets a first preset condition from the multiple second version numbers, and sending an installation file corresponding to the target version number to the client.

In an embodiment, the installation environment information includes at least one of operating system version information, a hardware identification code, and an installation mode, and the installation mode includes an upgrade installation mode or an initial installation mode.

In an embodiment, the installation parameter information includes at least one of an installation status identifier and a number of installation bluescreens, and the installation status identifier includes an installation success identifier or an installation failure identifier.

In an embodiment, the processor 1001 specifically performs the following operations when obtaining the multiple pieces of second installation information each including the target software identifier and the installation environment information:

selecting multiple pieces of second installation information each including the target software identifier and the installation environment information from pre-stored installation information indicating successful installation of the target software and pre-stored installation information indicating failed installation of the target software.

In an embodiment, the parameter statistics result includes at least one of installation success data and a number of installation bluescreens for each second version number, and the installation success data includes a number of successful installations or an installation success probability.

In an embodiment, the processor 1001 specifically performs the following operations when selecting the target version number of which the parameter statistics result meets the first preset condition from the multiple second version numbers:

when the parameter statistics result includes the installation success data, selecting the target version number of which the installation success data is greater than a success data threshold from the multiple second version numbers; or,

when the parameter statistics result includes the number of installation bluescreens, selecting the target version number of which the number of installation bluescreens is less than a first bluescreen number threshold from the multiple second version numbers; or,

when the parameter statistics result includes the installation success data and the number of installation bluescreens, selecting the target version number of which the installation success data is greater than the success data threshold and the number of installation bluescreens is less than the first bluescreen number threshold from the multiple second version numbers.

In an embodiment, the processor 1001 further performs the following operations:

selecting a third version number of which the parameter statistics result meets a second preset condition from the multiple second version numbers, and hiding or deleting the installation file corresponding to the third version number.

In an embodiment, the processor 1001 specifically performs the following operations when selecting the third version number of which the parameter statistics result meets the second preset condition from the multiple second version numbers:

when the parameter statistics result includes the installation success data, selecting the third version number of which the installation success data is less than the successful data threshold from the multiple second version numbers; or,

when the parameter statistics result includes the number of installation bluescreens, selecting the third version number of which the number of installation bluescreens is greater than the first bluescreen number threshold from the multiple second version numbers; or,

when the parameter statistics result includes the installation success data and the number of installation bluescreens, selecting the third version number of which the installation success data is less than the success data threshold and the number of installation bluescreens is greater than the first bluescreen number threshold from the multiple second version numbers.

In an embodiment, the first installation information further includes a number of restarts of the client when the target software fails to be installed.

The processor 1001 further performs the following operations before obtaining the multiple pieces of second installation information each including the target software identifier and the installation environment information:

obtaining multiple pieces of third installation information each including the target software identifier, the first version number and the installation environment information, and detecting whether a target number of restarts exists in the multiple pieces of third installation information, in which, for the target number of restarts, the installation status identifier is the installation success identifier, and the number of bluescreens is less than a second bluescreen number threshold;

if the target number of restarts does not exist, performing the step of obtaining the multiple pieces of second installation information each including the target software identifier and the installation environment information; and

if the target number of restarts exists, sending the target number of restarts to the client for prompting to restart.

In embodiments of the present disclosure, the first installation information sent by the client and indicating the failed installation of the target software is received, multiple pieces of second installation information each containing the same installation environment information as the first installation information are obtained, and the parameter statistics results corresponding to multiple second version numbers contained in the multiple pieces of second installation information are generated, the target version number of which the parameter statistics result meets the first preset condition is selected from the multiple second version numbers and the installation file corresponding to the target version number is sent to the client. In this manner, for the client with failed installation of the target software, the installation file that can be successfully installed can be timely sent to the client, making the target software run normally in the client and improving the successful installation efficiency of the target software.

In order to realize the above embodiments, the present disclosure further proposes a storage medium. The storage medium is stored thereon with one or more programs that, when executed by a device, cause the device to implement the installation file processing method according to embodiments of the present disclosure, wherein the method includes:

receiving first installation information sent by a client and indicating a failed installation of target software, the first installation information including a target software identifier, a first version number corresponding to the target software, installation environment information and installation parameter information;

obtaining multiple pieces of second installation information each including the target software identifier and the installation environment information, and generating parameter statistics results corresponding to multiple second version numbers contained in the multiple pieces of second installation information;

selecting a target version number of which the parameter statistics result meets a first preset condition from the multiple second version number and sending an installation file corresponding to the target version number to the client.

It should to be noted that, when the programs stored in the storage medium of the embodiment is executed by the device, the principle and implementation of executing the installation file processing method is similar to that of the installation file processing method of the above embodiments, which will not be elaborated here.

In order to realize the above embodiments, the present disclosure further proposes an application program. The application program is configured to perform the installation file processing method according to embodiments of the present disclosure when running, wherein the installation file processing method includes:

receiving first installation information sent by a client and indicating a failed installation of target software, the first installation information including a target software identifier, a first version number corresponding to the target software, installation environment information and installation parameter information;

obtaining multiple pieces of second installation information each including the target software identifier and the installation environment information, and generating parameter statistics results corresponding to multiple second version numbers contained in the multiple pieces of second installation information;

selecting a target version number of which the parameter statistics result meets a first preset condition from the multiple second version number and sending an installation file corresponding to the target version number to the client.

It should to be noted that, the principle and implementation of executing the installation file processing method by the application program of embodiments of the present disclosure is similar to that of the installation file processing method of the above embodiments, which will not be elaborated here.

For the device, storage medium and application program embodiments, since they are basically similar to method embodiments, the description is relatively simple. For the relevant content, please refer to the part description of method embodiments.

It should be understood that, the steps in the method described in embodiments of the present disclosure may be re-sequenced, combined and omitted according to actual needs. Accordingly, units in the device described in embodiments of the present disclosure may also be combined, divided and omitted according to actual needs.

What has been disclosed above are only preferred embodiments of the present disclosure and, of course cannot be construed to limit the scope of the present disclosure, those skilled in the art may understand all or part of the process for implementing the above embodiments and the equivalent changes made according to claims of the present disclosure shall remain within the scope of the present disclosure.

It should be understood that each part of the present disclosure may be realized by hardware, software, firmware or combination thereof. In the above embodiments, a plurality of steps or methods may be realized by software or firmware stored in the memory and executed by an appropriate instruction execution system. For example, if it is realized by the hardware, likewise in another embodiment, it may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

Although embodiments of present disclosure have been shown and described above, it should be understood that above embodiments are just explanatory, and cannot be construed to limit the present disclosure, for those skilled in the art, changes, alternatives, and modifications can be made to the embodiments without departing from spirit, principles and scope of the present disclosure.

It should be noted that the relational terms herein, such as “first” and “second”, are used only for differentiating one entity or operation, from another entity or operation, which, however do not necessarily require or imply that there should be any real relationship or sequence. Moreover, the terms “comprise”, “include” or any other variations thereof are meant to cover non-exclusive comprising, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

It should be noted that, in order to simplify description the present disclosure, embodiments of the present disclosure are expressed as a series of action combinations, but it would be appreciated by those skilled in the art that the present disclosure is not limited to the order of the actions, because some steps may be executed in other orders or be executed at the same time. In addition, it would be further appreciated by those skilled in the art that embodiments described in the specification are preferred embodiments, actions and modules involved therein may not be necessary for the present disclosure.

In above embodiments, descriptions of respective embodiments are emphasized differently, and parts that are not detailed in some embodiments can refer to relevant descriptions of other embodiments.

In the several embodiments provided in the present disclosure, it is understood that, the disclosed device may be implemented in other ways. For example, the device embodiment described above is schematic, for example, the division of the unit is only a division of logical function, which can be realized in another way, for example, multiple units or components can be combined or integrated into another system, or some features can be ignored or not implemented. On the other hand, the mutual coupling or direct coupling or communication connection shown or discussed may be indirect coupling or communication connection through some interface, device or unit, may be electrical or other forms.

The units described as separate parts may be or may not be physically separated, and the parts displayed as units may be or may not be physical units, that is, may be located in one place or may be distributed over multiple network units. Some or all of these units may be selected according to actual needs for the purpose of embodiments of the present disclosure.

In addition, each functional unit in each embodiment of the present disclosure may be integrated into a processing unit, may be physically separate from each unit, or may be integrated into one unit by two or more units. The integrated unit mentioned above can be implemented as either hardware or software functional unit.

The integrated unit, if implemented as a software functional unit and sold or used as an independent product, may be stored in a computer-readable storage medium. Based on such understanding, the technical solution of the present disclosure is essentially or the part that contributes to the existing technology or the whole or part of the technical solution can be reflected in the form of software products, the computer software product is stored in a storage medium and comprises instructions for enabling a computer device (which may be a personal computer, a server or a network device, etc.) to perform all or part of the steps described in each embodiment of the present disclosure. The aforementioned storage media include: U disk, ROM (Read-Only Memory), RAM (Random Access Memory), mobile hard disk, disk or optical disk and other media that can store program code.

As described above, the above embodiments are used only to describe the technical solution of the present disclosure, and are not intended to limit it; although the present disclosure is described in detail with reference to the embodiments, those skilled in the art should understand that they may still modify the technical solution recorded in the embodiments or replace some of the technical features thereof equally; such modifications or substitutions shall not remove the nature of the corresponding technical solution from the scope of the technical solution of each embodiment of the present disclosure.

The above are only preferred embodiments of the present disclosure and are not used to limit the scope of protection of the present disclosure. Any modifications, equivalents, improvements, etc., which are made within the spirit and principles of the present disclosure, are intended to be within the scope of the present disclosure.

1. An installation file processing method, comprising:
receiving first installation information sent by a client and indicating a failed installation of a target software, the first installation information comprising a target software identifier, a first version number corresponding to the target software, installation environment information and installation parameter information;
obtaining multiple pieces of second installation information each comprising the target software identifier and the installation environment information, and generating parameter statistics results corresponding to multiple second version numbers contained in the multiple pieces of second installation information;
selecting a target version number of which the parameter statistics result meets a first preset condition from the multiple second version numbers, and sending an installation file corresponding to the target version number to the client.

2. The method according to claim 1, wherein the installation environment information comprises at least one of operating system version information, a hardware identification code, and an installation mode, and the installation mode comprises an upgrade installation mode or an initial installation mode.

3. The method according to claim 1, wherein the installation parameter information comprises at least one of an installation status identifier and a number of installation bluescreens, the installation status identifier comprises an installation success identifier or an installation failure identifier.

4. The method according to claim 1, wherein obtaining multiple pieces of second installation information each comprising the target software identifier and the installation environment information comprises:
selecting the multiple pieces of second installation information each comprising the target software identifier and the installation environment information from pre-stored installation information indicating successful installation of the target software and pre-stored installation information indicating failed installation of the target software.

5. The method according to claim 1, wherein the parameter statistics result comprises at least one of installation success data and a number of installation bluescreens for each second version number, the installation success data comprises a number of successful installations or an installation success probability.

6. The method according to claim 1, wherein selecting a target version number of which the parameter statistics result meets a first preset condition from the multiple second version numbers comprises:
when the parameter statistics result comprises the installation success data, selecting the target version number of which the installation success data is greater than a success data threshold from the multiple second version numbers; or
when the parameter statistics result comprises the number of installation bluescreens, selecting the target version number of which the number of installation bluescreens is less than a first bluescreen number threshold from the multiple second version numbers; or
when the parameter statistics result comprises the installation success data and the number of installation bluescreens, selecting the target version number of which the installation success data is greater than the success data threshold and the number of installation bluescreens is less than the first bluescreen number threshold from the multiple second version numbers.

7. The method according to claim 1, further comprising:
selecting a third version number of which the parameter statistics result meets a second preset condition from the multiple second version numbers, and hiding or deleting the installation file corresponding to the third version number.

8. The method according to claim 7, wherein selecting the third version number of which the parameter statistics result meets the second preset condition from the multiple second version numbers comprises:
when the parameter statistics result comprises the installation success data, selecting the third version number of which the installation success data is less than a success data threshold from the multiple second version numbers; or
when the parameter statistics result comprises the number of installation bluescreens, selecting the third version number of which the number of installation bluescreens is greater than a first bluescreen number threshold from the multiple second version numbers; or
when the parameter statistics result comprises the installation success data and the number of installation bluescreens, selecting the third version number of which the installation success data is less than the success data threshold and the number of installation bluescreens is greater than the first bluescreen number threshold from the multiple second version numbers.

9. The method according to claim 1, wherein the first installation information further comprises a number of restarts of the client when the target software fails to be installed;
before obtaining multiple pieces of second installation information each comprising the target software identifier and the installation environment information, the method further comprises:
obtaining multiple pieces of third installation information each comprising the target software identifier, the first version number and the installation environment information, and detecting whether a target number of restarts exists in the multiple pieces of third installation information, in which, for the target number of restarts, the installation status identifier is the installation success identifier and the number of bluescreens is less than a second bluescreen number threshold;
if the target number of restarts does not exist, performing the step of obtaining multiple pieces of second installation information each comprising the target software identifier and the installation environment information; and
if the target number of restarts exists, sending the target number of restarts to the client for prompting to restart.

10. An installation file processing device, comprising:
a processor; and
a memory, configured to store instructions executable by the processor,
wherein the processor is configured to:
receive first installation information sent by a client and indicating a failed installation of target software, the first installation information comprising a target software identifier, a first version number corresponding to the target software, installation environment information and installation parameter information;
obtain multiple pieces of second installation information each comprising the target software identifier and the installation environment information, and generate parameter statistics results corresponding to multiple second version numbers contained in the multiple pieces of second installation information;
select a target version number of which the parameter statistics result meets a first preset condition from the multiple second version numbers; and
send an installation file corresponding to the target version number to the client.

11. The device according to claim 10, wherein the installation environment information comprises at least one of operating system version information, a hardware identification code, and an installation mode, and the installation mode comprises an upgrade installation mode or an initial installation mode.

12. The device according to claim 10, wherein the installation parameter information comprises at least one of an installation status identifier and a number of installation bluescreens, the installation status identifier comprises an installation success identifier or an installation failure identifier.

13. The device according to claim 10, wherein the processor is specifically configured to select the multiple pieces of second installation information each comprising the target software identifier and the installation environment information from pre-stored installation information indicating successful installation of the target software and pre-stored installation information indicating failed installation of the target software.

14. The device according to claim 10, wherein the parameter statistics result comprises at least one of installation success data and a number of installation bluescreens for each second version number, the installation success data comprises a number of successful installations or an installation success probability.

15. The device according to claim 10, wherein, the processor is specifically configured to:
when the parameter statistics result comprises the installation success data, select the target version number of which the installation success data is greater than a success data threshold from the multiple second version numbers; or
when the parameter statistics result comprises the number of installation bluescreens, select the target version number of which the number of installation bluescreens is less than a first bluescreen number threshold from the multiple second version numbers; or
when the parameter statistics result comprises the installation success data and the number of installation bluescreens, select the target version number of which the installation success data is greater than the success data threshold and the number of installation bluescreens is less than the first bluescreen number threshold from the multiple second version numbers.

16. The device according to claim 10, wherein the processor is further configured to:
select a third version number of which the parameter statistics result meets a second preset condition from the multiple second version numbers; and
hide or delete the installation file corresponding to the third version number.

17. The device according to claim 16, wherein, the processor is specifically configured to:
when the parameter statistics result comprises the installation success data, select the third version number of which the installation success data is less than a success data threshold from the multiple second version numbers; or
when the parameter statistics result comprises the number of installation bluescreens, select the third version number of which the number of installation bluescreens is greater than a first bluescreen number threshold from the multiple second version numbers; or
when the parameter statistics result comprises the installation success data and the number of installation bluescreens, select the third version number of which the installation success data is less than the success data threshold and the number of installation bluescreens is greater than the first bluescreen number threshold from the multiple second version numbers.

18. The device according to claim 10, wherein the first installation information further comprises a number of restarts of the client when the target software fails to be installed;
processor is further configured to:
obtain multiple pieces of third installation information each comprising the target software identifier, the first version number and the installation environment information;
detect whether a target number of restarts exists in the multiple pieces of third installation information, in which, for the target number of restarts, the installation status identifier is the installation success identifier and the number of bluescreens is less than a second bluescreen number threshold;
if the target number of restarts exists, send the target number of restarts to the client for prompting to restart; and
if the target number of restarts does not exist, perform obtaining multiple pieces of second installation information each comprising the target software identifier and the installation environment information, and generating parameter statistics results corresponding to multiple second version numbers contained in the multiple pieces of second installation information.

19. (canceled)

20. A storage medium, stored thereon with one or more programs that, when executed by a device, perform an installation file processing method, the method comprising:
receiving first installation information sent by a client and indicating a failed installation of a target software, the first installation information comprising a target software identifier, a first version number corresponding to the target software, installation environment information and installation parameter information;
obtaining multiple pieces of second installation information each comprising the target software identifier and the installation environment information, and generating parameter statistics results corresponding to multiple second version numbers contained in the multiple pieces of second installation information;
selecting a target version number of which the parameter statistics result meets a first preset condition from the multiple second version numbers, and sending an installation file corresponding to the target version number to the client.

21. (canceled)
